(19) United States
(12) Patent Application Publication
(10) Pub. No.: US 2015/0125801 A1
(43) Pub. Date: May 7, 2015

(54) DUAL HEAD CONNECTOR

(71) Applicant: OrthoAccel Technologies Inc., Bellaire, TX (US)

(72) Inventor: S Jay BOWMAN, Bellaire, TX (US)

(21) Appl. No.: 14/468,100

(22) Filed: Aug. 25, 2014

Related U.S. Application Data
(60) Provisional application No. 61/901,154, filed on Nov. 7, 2013.

(51) Int. Cl. A61C 1/08; A61C 7/00

(52) U.S. Cl. CPC A61C 1/08; A61C 7/008
USPC 433/2; 433/24

(57) ABSTRACT

An orthodontic remodeling device, having an extra-oral driver, a bite plate or other intra-oral orthodontic appliance, and a dual headed connector for connecting the two.

### PRIOR RELATED APPLICATIONS

This application claims priority to U.S. Ser. No. 61/901,154, filed Nov. 7, 2013, and expressly incorporated by reference herein in its entirety for all purposes.

### FEDERALLY SPONSORED RESEARCH STATEMENT

Not applicable.

### REFERENCE TO MICROFICHE APPENDIX

Not applicable.

### FIELD OF THE DISCLOSURE

The invention relates to biteplates and other orthodontic appliances for use with various extra-oral orthodontic remodeling devices, especially vibratory devices, wherein the connector that connects the bite plate or other appliance to the extra-oral device is dual headed, such that it can be disconnected from both the bite plate and the extra-oral device. This allows the bite plates to be more easily customized for use.

### BACKGROUND OF THE DISCLOSURE

Orthodontics, formerly orthodontia (from Greek orthos “straight or proper or perfect”; and odous “tooth”), is the specialty of dentistry concerned with the study and treatment of malocclusion, which can be a result of tooth irregularity, disproportionate facial skeleton relationship, or both. Orthodontics treats malocclusion through the displacement of teeth via bony remodeling and control and modification of facial growth.

This process has been accomplished for hundreds of years using static mechanical force to induce bone remodeling, thereby enabling teeth to move. In modern orthodontics, braces consisting of an archwire interfaces with brackets that are affixed to each tooth. As the teeth respond to the pressure applied via the archwire by shifting their positions, the wires are again tightened to apply additional pressure. This widely accepted approach to treating malocclusion takes about twenty-four months on average to complete, and is used to treat a number of different classifications of clinical malocclusion.

Treatment with braces is complicated by the fact that it is uncomfortable and/or painful for patients, and the orthodontic appliances are perceived as unaesthetic, all of which creates considerable resistance to use. Additionally, the average 24-month treatment time is very long, and cannot be shortened by increasing the forces, due to the risk of root resorption and possible tooth loss. Further, braces often result in white spot lesions, due to difficulty in maintaining adequate hygiene at brace contact points, and the risk of damage increases as orthodontic treatment time is extended. All of these factors reduce usage of orthodontic treatment. In fact, some estimates provide that less than half of the patients who could benefit from such treatment elect to pursue orthodontics.

Kesling introduced the tooth positioning appliance in 1945 as a method of refining the final stage of orthodontic finishing after removal of the braces (debanding). The “positioner” was a one-piece pliable rubber appliance fabricated on the idealized wax set-ups for patients whose basic treatment was complete.

Kesling also predicted that certain major tooth movements could also be accomplished with a series of positioners fabricated from sequential tooth movements on the set-up as the treatment progressed. However, this idea did not become practical until the advent of 3D scanning and computer modeling in 1997, when the Invisalign® system was introduced by Align Technologies®.

In addition to static forces, cyclic forces can also be used for orthodontic remodeling. Kopher and Mao assessed cyclic forces of 5N peak magnitude at 1 Hz in rabbits, while Peptan and Mao assessed cyclic forces of 1N at 8 Hz in rabbits, and Vij and Mao assessed cyclic forces of 300 mN at 4 Hz in rats. In aggregate, the data from these three studies indicated that cyclic forces between 1 Hz and 8 Hz, with forces ranging from 0.3N to 5N, increased bone remodeling, at least in rodent cranial studies. Rates depended on different methodologies, but increases of 2.5× with vibrational forces were common.

The early Mao studies provided a basis for both possible efficacy and likely safety for using vibration in humans to assist orthodontic tooth movement, but the animal studies needed to be repeatable in humans, and the device suggested by Mao were completely unsuitable for human clinical work.

OrthoAccel Technologies Inc., invented the first commercially successful dental vibrating device, as described in US2008227046 and related cases, designed to apply cyclic forces to the dentition for accelerated remodeling purposes. Both intra-oral and extra-oral embodiments are described in US2008227046, each having processors to capture and transmit patient usage information, which is an important tool in ensuring compliance.

The bite plate was specially designed to contact occlusal as well as facial and/or lingual surfaces of the dentition, and thus was more effective than any prior art devices in conveying vibrational forces to the teeth. Further, the device was tested in clinical trials and has been shown to speed orthodontic remodeling as much as 50%, and is truly a breakthrough in orthodontic technology (Kau 2010).

Finally, the device is slim, capable of hands free operation, lacks the bulky headgear of the prior art devices, and has optimized force and frequency for alveolar bone remodeling. Thus, its comfort level and compliance was also found to be high, with patients reporting that they liked the device, especially after the motor was redesigned to be quieter and smoother, as described in US2010055634 et seq. In fact, this device has been marketed as AcceleDent® in the United States, and several other countries and has achieved remarkable commercial success since its recent introduction. AcceleDent® represents the first successful clinical approach to accelerate orthodontic tooth movement by 50% via modulating bone biology in a non-invasive and non-pharmacological manner.

A new model was recently introduced to the US market, the AcceleDent®-Aura which further streamlined the device, and replaced a separate charging and data display station with a USB port accessible via a tethered hatch.

Although the AcceleDent® treatment device has been highly efficacious and commercially successful, it can always be improved, by e.g., by providing a bite plate with removable connectors, allowing the bite plate to be fully customized or be used for other treatment modalities.

This application addresses some of those improvements.

### SUMMARY OF THE DISCLOSURE

The invention is directed to a dual headed connector, that can be disconnected from a bite plate or other intra-oral orthodontic appliance and an extra-oral driver that provides some treatment modality, such as vibration. Thus, the bite plate or other appliance can be used at times when the extra-oral driver is not being used.

Positioners, for example, can be dual or single arch, the dual arch typically being limited to night use. The positioner could benefit from a reversible connection to the vibrating devices available from OrthoAccel, allowing a single arch positioner to be used throughout the day, without having an annoying connector protruding from the mouth, and still allowing the patient to take advantage of e.g., vibration to speed remodeling. Similarly, a splint is typically single arch and worn at night to relieve bruxism and to normalizing periodontal ligament proprioception, among other things. Clear retainers or aligners and splints and similar devices could also benefit from reversible connection to a device that provides micropulses to speed orthodontic remodeling.

Ser. No. 13/850,151, filed Mar. 25, 2013, describes a vibrating positioner, but did not expressly contemplate a dual headed connector, but instead used a socket in the bite plate, together with a protruding connector on the extra-oral device. While this does allow full daily usage of the positioner, it is not compatible with existing AcceleDent® or AcceleDent® Aura models, and therefore, this invention is an improvement thereon.

Another embodiment is the dual headed connector. Preferably such connector snap fits to both components.

Preferably, the inner core of the intra-oral component is designed such that the socket, which accommodates the dual headed connector, is flush or nearly flush with the front of the teeth, such that the lips can completely close over the bite plate when the connector is detached. In such cases, the inner core may need to increase somewhat in thickness to accommodate the connector, yet retain sufficient strength for repeated coupling and uncoupling. Thus, whereas the current connector is cylindrical at the driver side, it may be preferred to have a horizontal flat connector on the bite plate side.

It is preferred that the driver side connector retain the dimensions of the existing connector, so that the new bite plates can be coupled with the existing FDA cleared drivers. However, for any new product line, both connectors can use any known connection means, and preferably uses snap fit connectors.

Another embodiment is a bite plate or other intra-oral device core that reversibly fits to the dual head connector, allowing the core to be overlaid with a custom built orthodontic dual arch device, such as a positioner, mandibular advancement device, bruxism guard, sleep apnea bite plate, mandibular advancement devices, or other so-called “functional appliances,” temporomandibular joint (TMJ) or temporomandibular disorders (TMD) treatment devices and splints including, but not limited to the NTI®, and sport mouth-guards, and the like. The dual head connector can even be used with certain single arch devices, provided there are sufficient facial surfaces to accommodate the connector socket. Such devices might include a TMJ splint, certain twin block appliances, and the like.

The inner core of the intra-oral device can be made of e.g., metal or ceramic, but is preferably a moldable resin, and serves to provide support for connection to extra-oral remodeling devices, such as the vibrator, IR or micropulse devices. A stiffer resin, such as polyacrylate or polycarbonate, is preferred for strength of connection to the dual head connector, but if desired, the core can comprised a different material, such as metal, for the socket, and the remaining core be made of the desired resin. Thus, the core may have a socket, into which irreversibly snap fits a metal jacket, comprising a stronger material for reversible connection to the dual headed connector. Alternatively, the socket can be lined with a softer material (e.g., silicon rubber) in case the connector uses a friction fit.

In bite plates for vibration treatment modalities, the core is flat and sufficiently stiff so as to transmit vibration to the mouthpiece and thence to the teeth. In such cases, the core is also U shaped, allowing contact with the entire dentition, but where a core is, for example, to have e.g., a palatal expander function, the core may be lingual shaped, and moldable to fit the patient or a patient cast. Other core shapes are also possible, depending on the needs of the intra-oral device to be added thereto or built thereon.

The inner core can be built up on one or both sides with another resin and shaped for particular uses. Thus, the invention is particularly suited for use with custom-built devices. Alternatively, the core can be used alone, e.g., for a retainer, once shaped to fit a particular use. The core or core plus a shapeable resin can also be coated with another material that is FDA cleared for oral use, but preferably the materials used are FDA cleared or GRAS, and so an additional coating is not needed. Thus, it is contemplated that a lab may purchase cores, build any custom orthodontic or other treatment device on or around the core, and yet be able to temporarily and reversibly combine such custom bite plate with an extra-oral device, such as the AcceleDent®, which can speed boney remodeling by at least 50%.

The bite plate is preferably used with the existing extra-oral vibrational device, which is already cleared for marketing in the US and several other places and already has proven efficacy. However, the bite plate is also combinable with any other treatment modality, including any one or more of vibration, laser light, IR light, electromagnetic pulses, electrical micropulses, heat, cold, and the like.

The bite plate or other appliance can be assembled using the inner core, which is generally (but not necessarily) U-shaped to contact the occlusal surfaces of the Euro arch (e.g., narrowing as it progresses from the posterior (molar) to the anterior (incisor) teeth) and molding the tooth contacting surfaces thereon. Such surfaces can be made by any means known to or to be developed, and include heat molding, light curing, 3D printing, impression casting, and the like.

The finished bite plate can have a vertical edge (aka rim or phalange) to contact at least one of the facial and lingual surfaces of the teeth of both arches, especially for a vibrational treatment modality, as this allows the vibration to be in an up-and-down direction via the occlusal contact, as well as front-to-back direction via facial rim contact. The vertical edges thus allow the vibration to be transferred to the teeth in two axes, and are much preferred over a simple flat bite plate. The edges also serve to keep the bite plate correctly positioned over the teeth during vibration.

The preferred polymer for the bite plate has no taste or toxicity, does not leach components such as plasticizers (except where intended to release active agents such as fluoride), and is preferably tested for same before use according to known tests. Where a polymer does leach, it can be coated with a sealant, but a non-leaching polymer is preferred since sealants have a limited lifespan in an oral environment.

The most preferred materials are medical grade or FDA cleared for oral use and are tasteless, non-toxic, and biocompatible. Suitable resins may include an epoxy, a cyanoacrylate, an acrylate, a urethane, an acrylate and urethane mixture, a urethane oligomer/(meth) acrylate monomer blend resin, a silicone, a silicone copolymer, natural or synthetic rubber, rubber-substitutes, polyvinyl, or a copolymer of hydrogen siloxanes and unsaturated compounds. Silicone is particularly preferred.

Alternatively, the resin may comprise copolymers of hydrogen siloxanes and unsaturated compounds. These may be used as adhesion promoters to build a chemical link between the resin and the inner core. An example of such an adhesive is described in DE19934117 and incorporated by reference herein for all purposes. Other resins are described in e.g., U.S. Pat. No. 5,856,373; 2011/0200973; U.S. Pat. No. 5,017,626; U.S. Pat. No. 4,459,193; U.S. Pat. No. 4,411,625; U.S. Pat. No. 4,771,084; US20050049326.

Preferred polymers are clear, but colored pellets can be added to the polymer in the molten form, this making colored bite plates, which can appeal to younger patients. If desired, the outer surfaces can also be imprinted with designs, and if needed for longevity, can be coated with a sealant.

Additionally, fillers or coatings such as pearlescent white pigments, can be used to imitate the hue and luster of the teeth and blend the aligner with the natural teeth. Preferably, a refractive index of at least about 1.5-1.6 or 1.50-1.63 when measured using visible light under wet conditions will provide the appropriate luster of enamel.

By “U-shaped” what is meant herein is that the bite plates follow the curvature of the dentition, e.g., the biting surfaces of the teeth are in a substantially U-shaped curvature.

By “lingually shaped”, what is meant is that the bite plate is tongue shaped (e.g., like a U that has been filled in) such that it could function, e.g., as a palatal expander or retainer.

By “Euro arch” or “Euro form” herein what is meant is a dentition that narrows from the molars to the incisors. In contrast, other arch forms may be much rounder, or even having parallel sides, and not begin to narrow until closer to the front of the dentition.

When we refer to contacting “the teeth” or similar phrase herein, what is meant is the entire dentition, e.g., the teeth of both arches. If less than the entire dentition is intended, it will be referred to as maxillary teeth, mandibular teeth, or a “portion” of the teeth or specific teeth or arches will be identified by name. Nevertheless, the bite plate need not contact every single tooth, since by definition some malocclusions may results in one or more teeth considerably out of alignment. The phrase also allows some leeway at the molars to accommodate the fact that dentition varies in size, and that molars erupt over 20-25 years of age, if at all, or may be removed to provide additional space for the remaining teeth, and thus most patients will not have a full set of adult teeth. Therefore, a bite plate intended to contact all teeth of the average youth patient, may not reach the molars of older patients, or patients with more mature dentition.

When we refer to contacting “occlusal and facial surfaces of the teeth,” what is meant is that all teeth are intended to be contacted, allowing of course for badly misaligned teeth, which cannot be reached early in treatment, and allowing for leeway in molar contact.

By “treatment modality” what is meant is a mode of action that causes an orthodontic benefit.

By “treatment modality source,” what is meant is a device or component of a device that provides the treatment modality. For example, vibration is an orthodontic treatment modality and a vibratory source provides vibration. A vibratory source could also be called a vibrator. Another treatment modality is infrared or ultraviolet light, and an LED or laser could be an exemplary light source.

An “intra-oral orthodontic device”, or “intra-oral orthodontic appliance” is any orthodontic appliance used inside the mouth that can be used with an extra-oral driver, as defined herein.

A “bite plate” as used herein includes the many other orthodontic, dental, medical or protective devices worn inside the mouth and generally contacting occlusal surfaces of the teeth, such that the device is held by the patient “biting” on the bite plate.

By “core” or “inner core” herein we refer to the inner core of an intra-oral orthodontic appliance, which includes at least a housing and a socket in said housing, and onto which other components can be built or added thereto, or which can itself be shaped for a custom appliance. The inner core can be shapeable, however, and in such cases can be shaped to provide a finished intra-oral device without addition of other components.

An “extra-oral driver” is the extra-oral component that provides the treatment modality, and in preferred embodiments is a housing having an e.g., a treatment modality source such as a vibrator or laser, a processor, a battery or other power source, and the wiring needed to operatively couple or operate same, and wherein the housing has a socket for receiving the dual headed connector which also connects to the intra-oral device. The housing will preferably be water resistant or waterproof.

By “socket” what is meant is a hole or recession or female end into which a male end connector can fit.

By “housing” what is meant is that component that encloses and houses the socket since a hole cannot exist independently of some structure. “Housing” is also used for the exterior surface or container for the extra-oral driver components.

“Orthodontic remodeling” is used consistently with its art-accepted definition, and refers to the realigning of teeth by boney remodeling under forces sufficient to provide osteoclastic activity on the high-pressure side, and osteoblastic activity on the reduced-pressure side, but with minimal root resorption, such that teeth are gradually moved and/or realigned to a desired position.

“Orthodontic forces” is used consistently with its art-accepted definition, and refers to the steady (static) realigning forces needed for orthodontic remodeling.

“Orthodontic remodeling appliances” or “orthodontic appliances” are used consistently with art-accepted definitions, and refers to those devices that provide orthodontic forces and thus the realigning of teeth. The term includes a variety of devices, such a braces, aligners, positioners, Herbst, sagittal appliance, palatal expander, pendulum, Nance, and the like. The term does not include dental cleaning devices, such as electric toothbrushes, or professional cleaning tools such as scalers, and the like.

“Micropulses” are the very small vibrations or cyclic forces that are now known to cause 50% faster orthodontic remodeling when combined with an orthodontic force.

“Headgear” is used consistently with its art accepted definition, and refers to various head and neck attachment means used to provide orthodontic forces in a particular direction that cannot be easily be achieved with intra-oral attachment points.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated. When used in the context of part dimensions the term “about” includes that degree of tolerance that still allows the parts to operably connect, and thus will vary somewhat based on the flexibility of the material used for the part.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention. Thus, the term consisting essentially of excludes only material elements that change the nature of the invention, such as e.g., bulky headgear, toothbrush bristles, and the like.

### BRIEF DESCRIPTION OF THE DRAWINGS

FIG. 1 shows dental nomenclature. Tooth names: 1=central incisor (first incisor); 2=Lateral incisor (second incisor); 3=canine (cuspid); 4=first premolar (first biscuspid); 5=Second premolar (second bicuspid); 6=first molar; 7=second molar; 8=third molar. These are eight tooth names included in each quadrant of the dental arches. They are repeated to include right, lift, maxillary and mandibular, making a total of thirty-two teeth in all.

FIG. 2 shows oral anatomy.

FIG. 3 shows a perspective view of the prior bite plate.

FIG. 4 shows the inner core of the prior art bite plate, designed to fit the existing AcceleDent® device.

FIG. 5A-C shows the connector parts, as well as various dimensions of the preferred driver side connector. When these dimensions are used, the connector will allow reversible coupling to the AcceleDent®.

FIG. 6 shows a dual headed connector with dual prong cantilevered snap fit connector connecting to a suitable matching socket on an inner core.

FIG. 7 shows a dual headed connector with luer-lock connection to a suitable matching socket on an inner core. Luer locks are common in the medical device industry and used to couple syringes and needles.

FIG. 8 shows a dual headed connector with another dual prong cantilevered snap fit connector connecting to a suitable matching socket on an inner core.

FIG. 9 shows a dual headed connector with cylindrical snap fit connector connecting to a suitable matching socket on the inner core.

FIG. 10 shows a different bite plate inner core shape, in this case having the same housing a socket as above, but with just a central stub onto which various custom orthodontic devices or appliances can be built.

FIG. 11 shows another variation of the inner core for the bite plate, having just the socket and housing containing same. Such an embodiment might be suitable where the bite plate needs to be particularly thin. A custom bite plate is added behind the housing.

FIG. 12 shows another variation of the inner core for the bite plate, having just the socket and housing containing same, the housing also containing small stubs at each end, providing a base onto which the lab can build a custom orthodontic device.

### DETAILED DESCRIPTION

The disclosure describes a bite plate having a socket therein, preferably having many of the characteristics of the special prior art bite plates described in US2008227046, US2008227047, US2010055634, US20120322018, 61/624,242, 61/615,480 and 61/673,236 and intended to be used with intra-oral or extra-oral vibratory or other treatment modality sources, as described in the preceding applications for patent, each incorporated by reference in their entireties.

Also included is a dual head connector, for connecting the socketed bite plate to a socketed driver. Preferably, the driver end has the same dimensions as the existing bite plate, and can therefore be used with the existing drivers that are already on the market. The other end can be any suitable connector, including snap fitting connectors, cantilevered snap fits, threadable screw fits, luer lock-style fits, friction fits, and the like. The bite plate or other appliance will of course be modified to provide a socket for receiving such connector.

The extra-oral vibrator comprises at least a housing (preferably water resistant or waterproof) containing a vibrating motor operably coupled to a power source and an activation switch. In preferred embodiments, the housing also contains a processor to control the vibrating motor and to capture and transmit usage data to another device or monitoring parent or clinician. As noted above, other treatment modalities can be contained within the housing in addition to or in place of the vibrator.

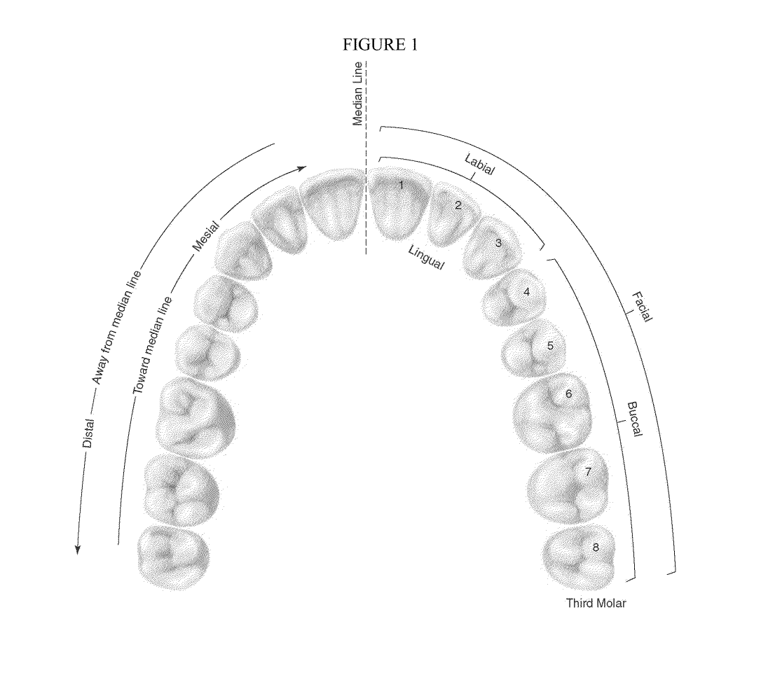

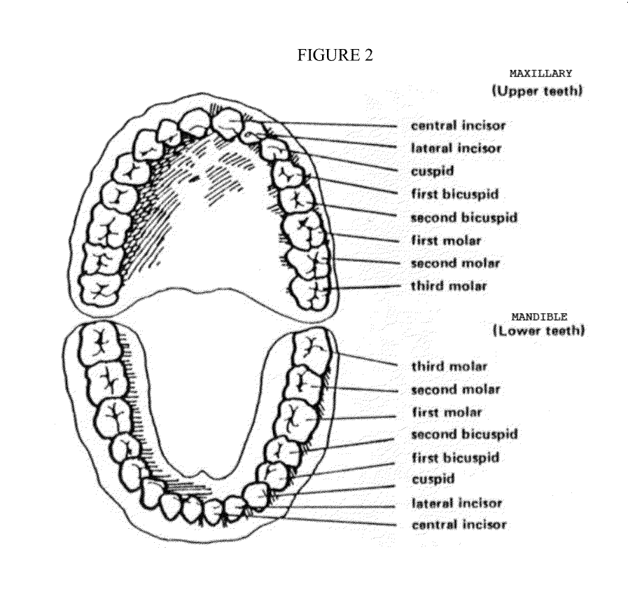

FIG. 1 shows standard dental nomenclature to orient the reader to the median line, where the bite plate socket is positioned. FIG. 2 identifies each of the maxillary and mandibular teeth.

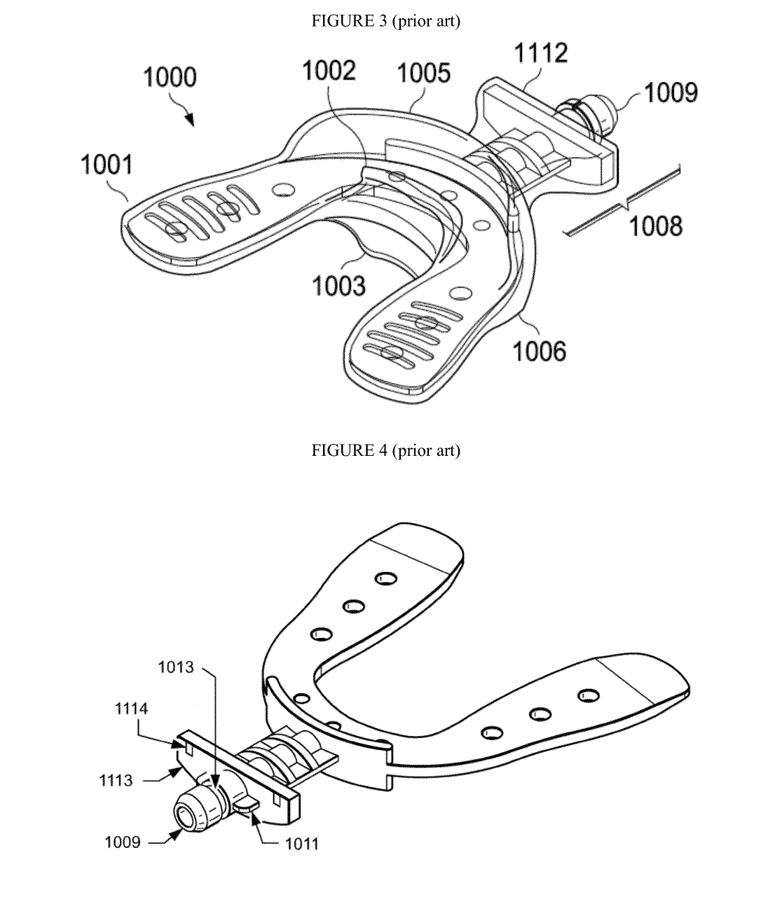

FIG. 3 shows a prior art bite plate 1000 from a perspective view. The bite plate has a generally U-shaped base 1001 that contacts occlusal surfaces of the teeth, the bite plate having front (outer edge of the U) and back (inner edge of the U) edges, one or both edges having a rim to contact the facial and lingual surfaces of teeth and gums. Thus, upper lingual rim 1002, lower lingual rim 1003, upper facial rim 1005 and lower facial rim 1006 are shown.

Also shown is the stem 1008, which is the portion of the bite plate 1000 that mates with a corresponding socket in the extra-oral housing (not shown here), which contains the power source, vibratory source or other treatment modality source, processor for controlling the device and providing optional compliance features.

In more detail, a cylindrical shaft 1009 is shown, having a groove into which a spring or jump ring 1010 fits, and mates with a corresponding depression in the socket. Optional flare 1112 is also shown, and is configured to provide an appropriate surface so that the user can push the stem into the socket.

FIG. 4 shows just the inner core 1007 of the bite plate, typically made from a resin, metal or ceramic having a harder durometer than the outer surface, and providing sufficient rigidity to the stem 1008 so as to allow it to lockingly fit into the socket of the extra-oral component of the device. Cylindrical shaft 1009 has a groove 1013, into which jump ring 1010 fits. Also, seen are locking pins 1011 that can also function as orientation pins if asymmetric, to prevent the bite plate from being inserted upside down. Generally plastics of at least 40 Shore D were used for the core, but metals or ceramics could also be used. Optional depressions 1114 on the base 1113 receive pins from the driver.

A coating is provided over this core, and provides the final shape of the bite plate, as shown in FIG. 3. Such coating should be a biocompatible soft polymer of 40-70 Shore A, and particularly preferred is a medical grade, clear silicone.

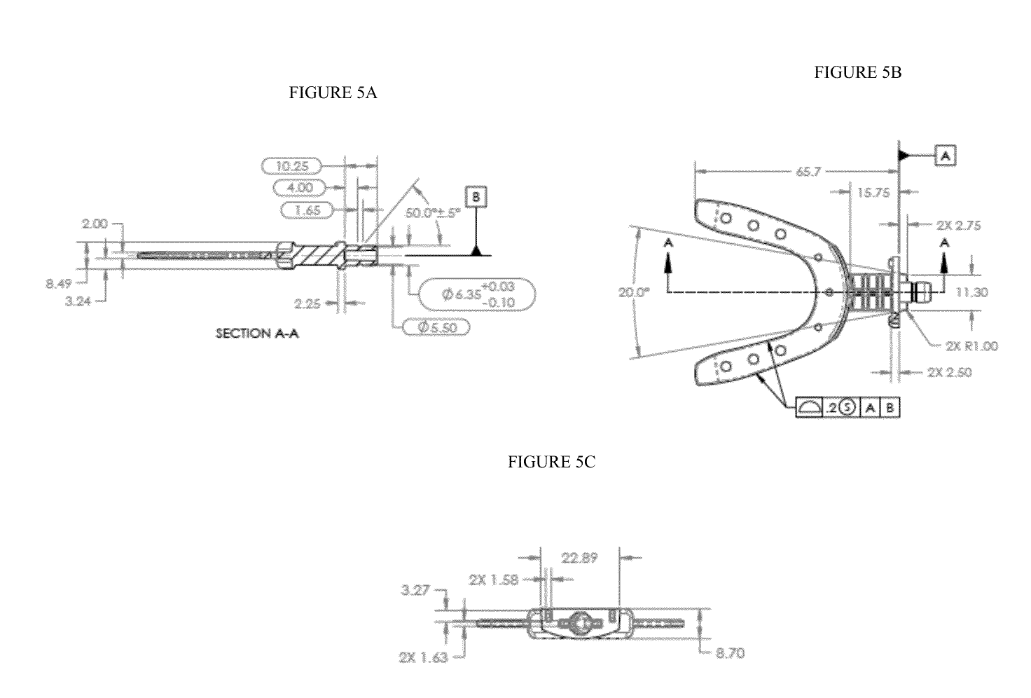

Preferably, the driver side connector is identical to that found on the AcceleDent® and AcceleDent-Aura™ and is shown in detail in FIG. 5A-C. Using similar connectors allows the bite plates to be interchangeable, and also allows any bite plate inventory to be used even when the driver unit model is updated. Thus, these sizes are valuable for interchangeability of parts. The minimum for interchangeable parts requires the cylindrical post of at least 10.25 mm in length×6.35 mm in diameter (tolerance noted to be +0.03, −0.1) mm with a groove 4 mm from the attached end of the post.

The connector has a flared base (flare not shown herein because made from the overcoating material, but can be seen in FIG. 3) with a flat surface opposite the bite plate, from which protrudes a centrally positioned cylindrical post that is 6-7 (6.35+0.03, −0.1) mm in diameter, 10-11 (10.25) mm in length, and having a groove circumventing the post about half way (4 mm from flat surface, with width of 1.65 mm, depth of 6.35-5.5=0.85).

The flared base is somewhat dumbbell shaped in cross section, thus providing a convenient thumb/finger engagement surface for pressing the bite plate connector into the corresponding socket of the driver. However, this feature is not essential for interchangeability and can be omitted.

The bottom of the post also has a pair of ˜1.4×3 mm pins projecting 180° from each other (in the same plane as the occlusal contacting base of the bite plate). These pins have a total spread of 11.30 mm at the topmost edge, but flare 10° on each side (20° total) to reach the flat surface of the base. The pins are 1.63 mm thick, and 2.75 mm high. The pins are optional, and a connector will still fit into the same driver.

The base of the connector also preferably has a pair of recessions ˜1.5 mm wide×3 mm long×2 mm deep (1.58×3.27×2.5 mm) on the flat surface thereof for engaging clips from the driver, the recessions being about 16-17 mm apart (22.89 mm in spread), and positioned right below the pins. The recessions can be omitted however, if the base is either not flared or is otherwise smaller, such that the remaining post and pins still fit, leaving the engaging clips on the driver free. These dimensions are approximate, and exact dimensions are provided on FIG. 5, although some tolerance of dimensions can be accommodated and still fit, as indicated in the claim language by use of the word “about”.

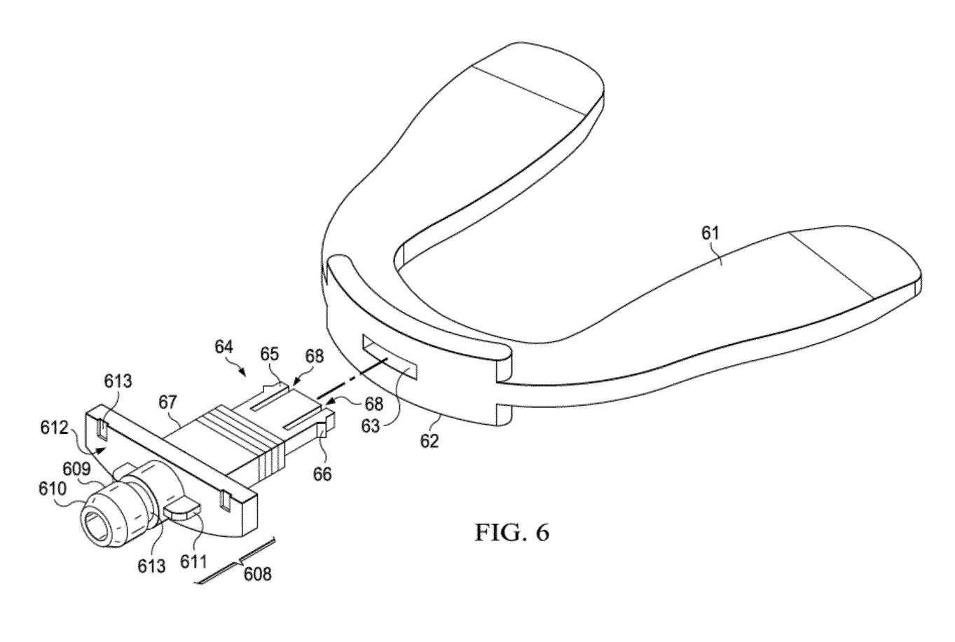

FIG. 6-9 show a variety of dual head connectors and the corresponding socket on the inner core of the orthodontic appliance.

FIG. 6 shows an inner core 61 fitted with a housing 62 for a socket 63, in this case shaped to receive a rectangular snap fit, such as is found on certain electronic device fittings.

The dual headed connector has the same connector 608 on the driver side as the prior art bite plates. Thus, base 612 has recessions 613 for pins from the driver. Base 612 can also be shaped to provide a convenient surface to provide pressure for insertion of the connectors into the socket, or an outer coating can provide such surface. Wings or fins 611 serve to control orientation of insertion. Groove 613 fits a jump ring (not shown) and cylindrical stem 609 has a beveled edge 610 for ease of insertion.

On the bite plate side, a housing 67 holds a snap fit connector 64, which is rectangular, having a pair of slots 68 that create the cantilevered posts or prongs 65. If the snap fit portion 64 is made of metal, it can be held by housing 67, but the housing is optional if the device is all of one piece or integral, e.g., made by injection molded plastic. Bumps or projections 66 provide the snap fit (fitting into recession in socket for same) and resistance against removal, but with sufficient force, the prongs 65 can be compressed sufficiently for removal.

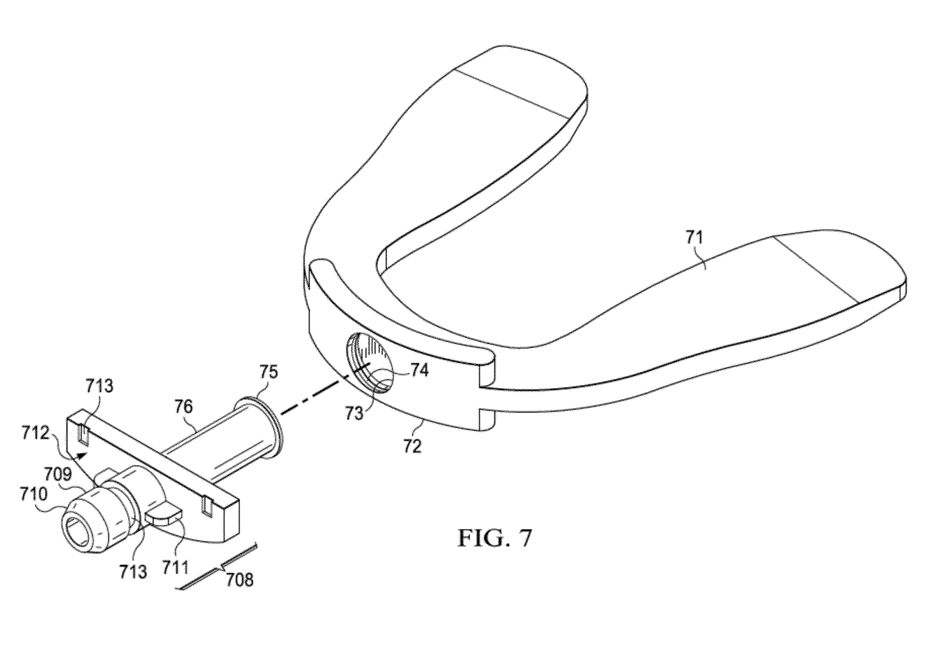

FIG. 7 is similar, but has a luer lock type connector on the bite plate 71 side, wherein the socket 73 has a spiral groove or track, into which the thread or protruding rim or edge 75 on the bite plate connector 76 can be screwed or threadably engaged. The driver side connector 708 has the same parts as described in FIG. 6.

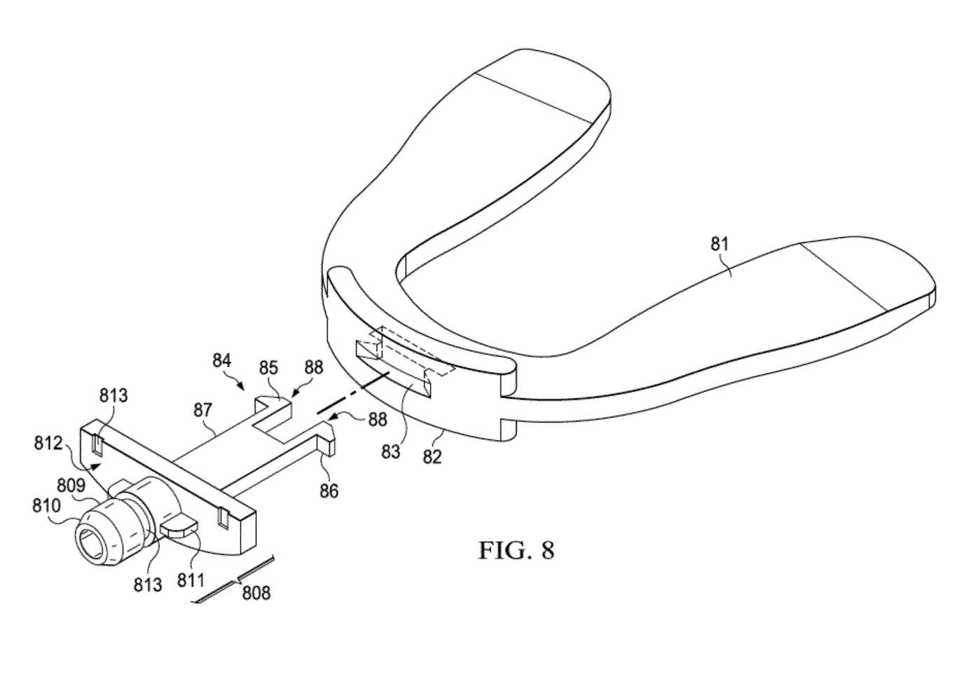

FIG. 8 shows a dual cantilever prong type bite plate side connector, where in the bite plate side of the dual headed connector is integral, and made e.g., of injection molded plastic or resin. Bite plate 81 has a housing 82 into which is molded or drilled or fitted a socket 83, shaped to received the dual prong connector 87. The connector has base 87, dual prongs 85, and protrusions 86, which fit into corresponding recessions inside the socket. The entirely of the dual head connector can be integral, as can the entirety of the bite plate, as such shapes are easily made by injection molding with sufficient strength, flex and tolerances for an excellent snap fit.

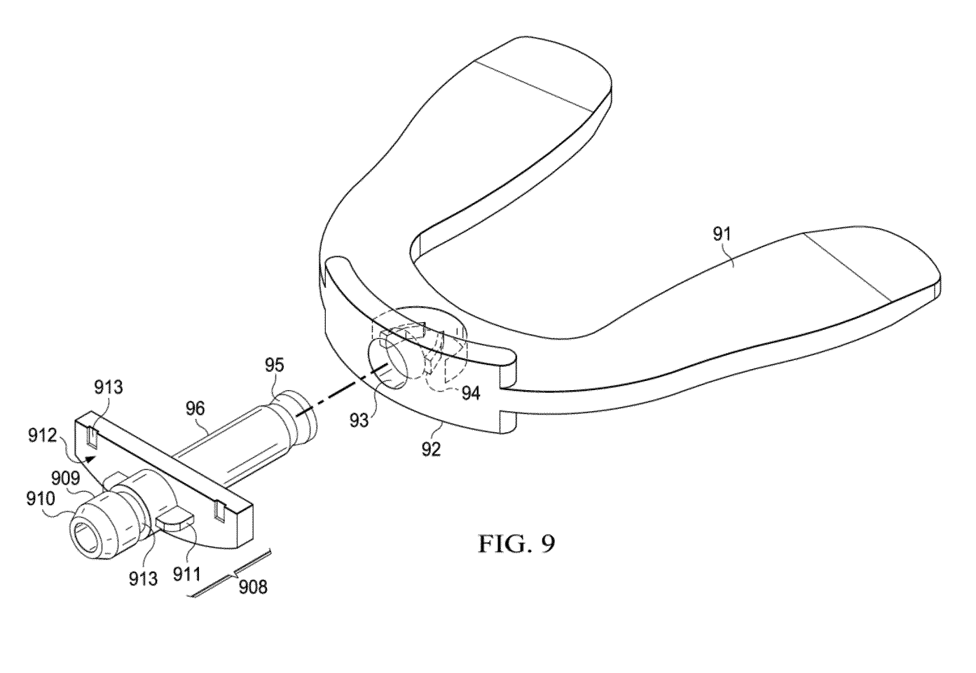

FIG. 9 shows a cylindrical snap fit bite plate side connector, wherein bite plate 91 has a housing 92 for a socket 92, which has prongs 94 therein that can be spread apart for a snap fit when cylindrical stem 96 is pushed therein. Prongs 94 will grip circumferential groove 95 when in place.

The above figures generally contemplate a bite plate inner core that is U-shaped, and provides a surface onto which a laboratory can build any custom device. However, the core need not be U-shaped, but can simply be the housing and socket and the remainder of the bite plate or other orthodontic device can be built onto the backside of the housing.

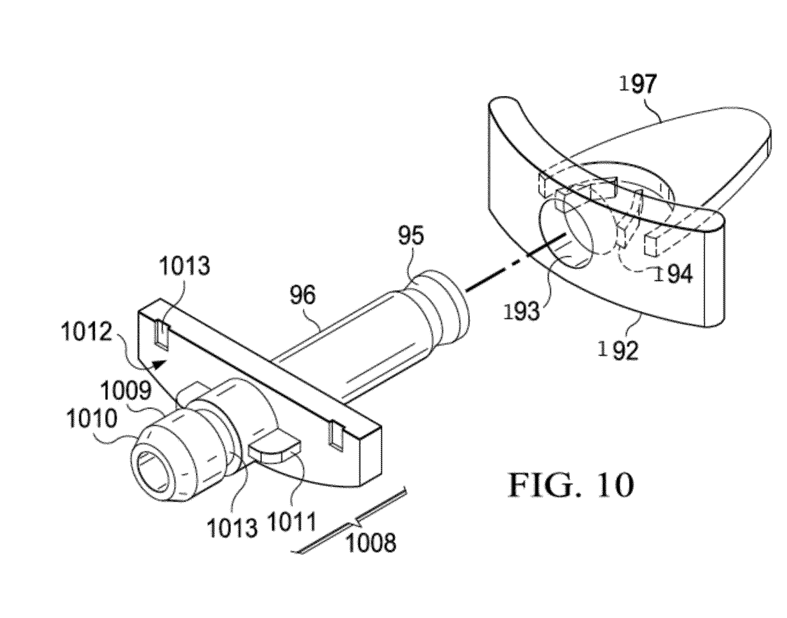

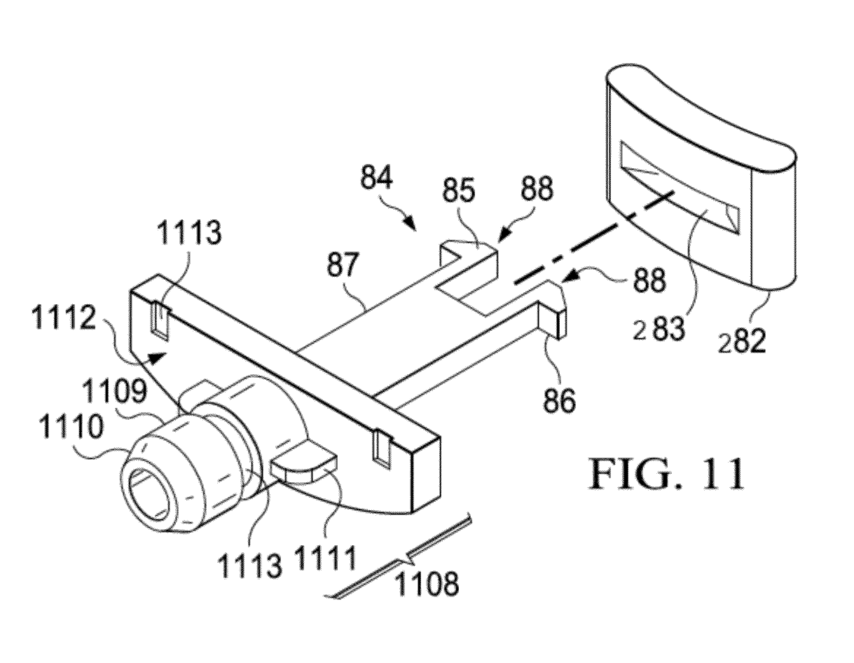

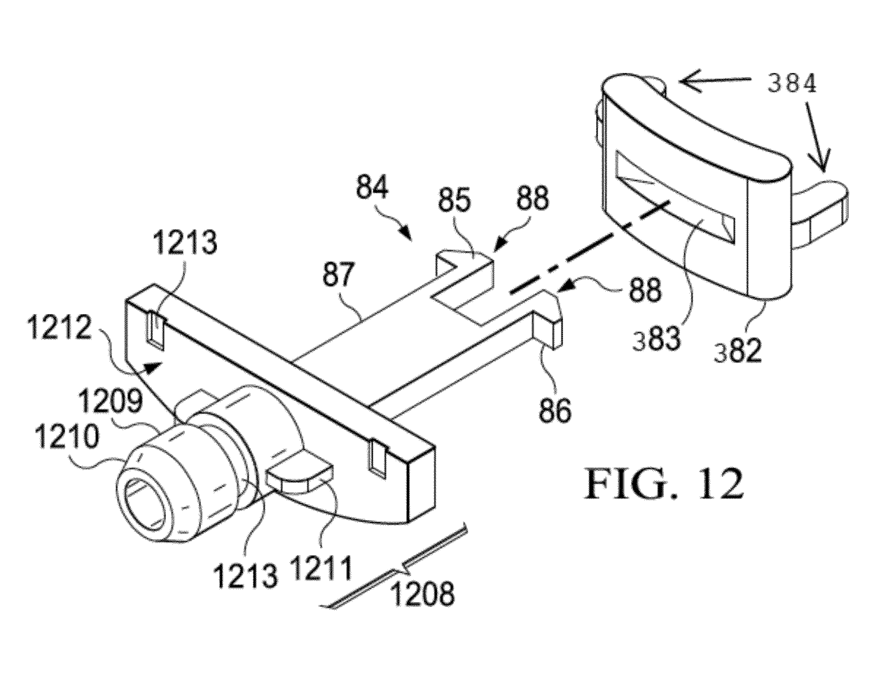

Therefore, FIG. 10-12 show a variety of device cores that provide the needed housing and socket for connecting to an extra-oral device, but the cores are of differing shapes. FIG. 10 provides a central stub 197 attached to housing 192, in which is socket 193 and prongs 194. The remainder of the components is the same. FIG. 11 just provides the housing 282 and socket 283. The housing 383 in which socket 383 is provided also has small stubs 384 in FIG. 12. Thus, the inner core of the bite plate is not necessarily U-shaped, but can be finished by the lab to provide variety of shapes, including U-shaped, lingually shaped, and non-symmetrical shapes. The driver side connector 1008, 1108, and 1208 has the same parts as described in FIG. 6.

The following are incorporated by reference here in their entireties.

US2008227046, US2008227047, US2010055634, US20120322018, US2013059263, 61/624,242, 61/615,480 and 61/673,236, 61/769,507, 60,906,807

Ser. No. 13/850,151, filed Mar. 25, 2013.

Kau, et al., The clinical evaluation of a novel cyclical force-generating device in orthodontics, Orthodontic Practice 1(1) (2010).

While the invention is described above in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. An orthodontic remodeling system, comprising:
a. a dual headed connector for reversibly coupling an intra-oral orthodontic appliance having a first socket and an extra-oral orthodontic remodeling driver having a second socket,
b. said dual headed connector comprising:
i) a first connector for reversibly coupling to said first socket; and,
ii) a second connector for reversibly coupling to said second socket.

2. The system of claim 1, wherein said first connector snap fits to said first socket or said second connector snap fits to said second socket.

3. The system of claim 1, wherein said first connector and said first socket are threadably engaged.

4. The system of claim 1, wherein said extra-oral orthodontic remodeling driver includes a housing containing a vibrator operably coupled to an power source operably coupled to an processor for controlling device usage and for recording and transmitting usage compliance data.

5. The system of claim 1,
a) said second connector comprising a cylindrical shaft having a free end and an attached end; and,
b) said cylindrical shaft having a diameter of about 6.35 mm and a length of about 10.25 mm and having a groove about 4 mm from said attached-end, wherein said groove circumnavigates the shaft.

6. The system of claim 4,
a) said second connector comprising a cylindrical shaft having a free end and an attached end; and,
b) said cylindrical shaft having a diameter of about 6.35 mm and a length of about 10.25 mm and having a groove about 4 mm from said attached-end, wherein said groove circumnavigates the shaft.

7. The system of claim 4, said vibrator vibrating at a single frequency between 20-40 Hz and at a single force between 0.1-0.5 Newtons.

8. The system of claim 4, said vibrator vibrating at 30 Hz and 0.2 Newtons.

9. An orthodontic remodeling system, comprising
a) a U-shaped bite plate having vertical edges for contacting facial surfaces of upper and lower teeth;
b) said bite plate having a first socket;
c) an extra-oral vibrator having a second socket; and,
d) a dual headed connector having a first connector for reversibly connecting to said first socket and a second connector for reversibly connecting to said second socket.

10. The orthodontic remodeling system of claim 9, wherein said bite plate is U-shaped or lingually shaped.

11. The orthodontic remodeling system of claim 9, said extra-oral vibrator comprising a housing containing a vibrating motor operably coupled to a power source and an activation switch.

12. The orthodontic remodeling system of claim 11, said housing also containing a processor operably coupled to said vibrating motor and said activation switch, said processor for controlling said vibrating motor and for capturing and transmitting usage compliance data.

13. The orthodontic remodeling system of claim 9, said vibrator vibrating at a selected frequency between 20-40 Hz and a selected force 0.1-0.5 Newtons.

14. The orthodontic remodeling system of claim 9, said vibrator vibrating at 30 Hz and 0.2 Newtons.

15. The orthodontic remodeling system of claim 9,
a) said second connector comprising a cylindrical shaft having a free end and an attached end;
b) said cylindrical shaft having a diameter of about 6.35 mm and a length of about 10.25 mm and having a groove about 4 mm from said attached-end, wherein said groove circumnavigates the shaft.

16. The orthodontic remodeling system of claim 14,
a) said second connector comprising a cylindrical shaft having a free end and an attached end;
b) said cylindrical shaft having a diameter of about 6.35 mm and a length of about 10.25 mm and having a groove about 4 mm from said attached-end, wherein said groove circumnavigates the shaft.

17. A dual headed connector,
a) said dual headed for reversibly coupling an intra-oral orthodontic appliance having a first socket and an extra-oral orthodontic remodeling driver having a second socket;
b) said dual headed connector comprising:
i) a first connector that lockingly fits into said first socket; and,
ii) a second connector that lockingly fits to said second socket.

18. The dual head connector of claim 17, wherein said first connector is a dual prong cantilevered snap fit connector.

19. The dual head connector of claim 17,
a) said second connector comprising a cylindrical shaft having a free end and an attached end;
b) said cylindrical shaft having a diameter of about 6.35 mm and a length of about 10.25 mm and having a groove about 4 mm from said attached-end, wherein said groove circumnavigates the shaft.

20. The dual head connector of claim 17, wherein said first connector is a dual prong cantilevered snap fit connector, and said second connector is a cylindrical shaft having a free end and an attached end, said cylindrical shaft having a diameter of about 6.35 mm and a length of about 10.25 mm and having a groove about 4 mm from said attached-end, wherein said groove circumnavigates the shaft.

21. An inner core for an orthodontic appliance,
a) said inner core having a first socket on an interior facial surface thereof for receiving the dual headed connector of claim 17;
b) said inner core providing a base onto which a custom orthodontic appliance can be built.

22. A method of faster orthodontic remodeling, said method comprising wearing the bite plate of claim 9, attaching said extra-oral vibrator and vibrating said bite plate for about 20 minutes a day, wherein orthodontic remodeling is faster with said vibration than without said vibration.

23. A method of faster orthodontic remodeling, said method comprising a patient wearing a fixed orthodontic appliance or aligner wearing the bite plate of claim 14, attaching said extra-oral vibrator and vibrating said bite plate for about 20 minutes a day, wherein orthodontic remodeling is about twice as fast with said vibration as without said vibration.
